(19) United States
(12) Patent Application Publication
(10) Pub. No.: US 2015/0197252 A1
(43) Pub. Date: Jul. 16, 2015

(54) LOCK UP CLUTCH (LUC) CONTROLS - ENGINE CONTROL WHEN LUC CHANGES STATE

(71) Applicant: Caterpillar Inc.,, Peoria, IL (US)

(72) Inventors: MATTHEW TINKER, PEORIA, IL (US); JOHN REEDY, PEORIA, IL (US); KEVIN KNOX, PEORIA, IL (US)

(73) Assignee: Caterpillar Inc.,, Peoria, IL (US)

(21) Appl. No.: 14/154,877

(22) Filed: Jan. 14, 2014

(51) Int. Cl. B60W 30/20; B60W 10/06; B60W 10/10; B60W 10/02

(52) U.S. Cl. CPC B60W 30/20; B60W 10/026; B60W 10/06; B60W 10/10; B60W 2030/203; B60W 2030/206

(57) ABSTRACT

An engine control system is provided where the engine control system includes a torque converter, an engine connected to the torque converter, a transmission connected to the torque converter, a lock-up clutch housed in the torque converter wherein the lock-up clutch is configured to mechanically connect the engine and the transmission when the lock-up clutch is engaged, and an engine control module that is configured to operate the engine at a first torque lug curve when the lock-up clutch is engaged and operate the engine at a second torque lug curve when the lock-up clutch is disengaged.

### TECHNICAL FIELD

This disclosure relates generally to an integrated engine and transmission control and more specifically, to a system which regulates a lock-up clutch to mechanically lock the engine to the transmission.

### BACKGROUND

Hydrodynamic torque converters have long been used in constructions vehicles having automatic transmissions. The hydrodynamic torque converter uses hydrodynamic fluid as a transfer medium to deliver engine torque to the automatic transmission. Slippage, however, occurs between the input element and the output element of the torque converter when power transmission is carried out using the fluid medium. This hydrodynamic transfer of power between the engine and transmission provides for a smooth operation of the vehicle, but is not as efficient due to slippage and requires more fuel. Therefore, a lock-up clutch is often used with hydrodynamic torque converters to ensure that torque flow is transferred directly without any loss of power between the engine and the transmission. The lock-up clutch mechanically couples the input element to the output element of the torque converter such that the engine torque output is directly transferred to the transmission without any slippage or losses. Operating the vehicle using the lock-up clutch is generally preferable because it is more efficient and uses less fuel.

Lock-up clutches, however, suffer from disadvantages or drawbacks associated with the harshness experienced by the operator of the vehicle as a result of the engagement and disengagement of the lock-up clutch in the torque converter. The harshness refers to the jerking motion that the operator feels when the lock-up clutch either engages or disengages. For example, during engagement of the lock-up clutch, there is an increase in engine torque, which causes the vehicle to accelerate. Conversely, during disengagement of the lock-up clutch, there is a decrease in engine torque, which causes the vehicle to decelerate. The sudden acceleration and deceleration creates an undesired shock or jerking motion thrusting the operator forward or backwards during operation of the vehicle. This shift shock is problematic because it negatively affects the operator's comfort and the drivability of the vehicle. In some cases, the harshness may even undermine the operator's confidence in the vehicle's performance.

Furthermore, environmental concerns and recent regulations have created an increased demand for vehicles, including construction vehicles, to further improve their fuel economy. Proper operation of the power transmission and in particular, use of the lock-up clutch can be important to achieving fuel economy. As a result, construction vehicles will generally operate with the lock-up clutch engaged to maximize power and reduce fuel consumption. But, depending on the load cycle and service condition of the vehicle, the vehicle may need to periodically disengage the lock-up clutch.

There are many different approaches known in the prior art that attempt to prevent or reduce the harshness of the lock-up torque converter. For example, a typical strategy for engagement of a lock-up clutch can be seen in U.S. Patent Pub. No. 2011/196588 (the '588 publication) to Hofler et al., which published on Aug. 11, 2011. The '588 publication discloses a method of engaging a lock-up clutch that reduces or prevents the jerking motion of the lock-up clutch engagement by using a transmission control unit to control the gradient of the engine torque for a defined period of time after the lock-up clutch is engaged. An additional example of a system for engaging a lock-up clutch can be seen in U.S. Pat. No. 6,042,507 (the '507 patent) to Genise et al., granted Mar. 28, 2000. The '507 patent discloses a control system for ramping down engine torque to a desired lower torque level during engagement of the lock-up clutch to achieve a smooth torque converter lockup.

While these prior art methods and systems may address shift shock to some extent, they do not necessarily maximize fuel efficiency. Therefore, there is a need for a control system for a vehicle that operates the lock-up clutch of a torque converter such that the vehicle has improved drivability and comfort while also maximizing fuel efficiency.

The presently disclosed system and method is directed at overcoming one or more of these disadvantages in currently available lock-up clutches for torque converters.

### SUMMARY OF THE INVENTION

Accordingly, it would be desirable to have a device that addresses some of the issues occurring during the lock-up clutch engagement as described above.

In accordance with one aspect of the disclosure, an engine control system is provided where the engine control system includes a torque converter, an engine operatively connected to the torque converter, a transmission operatively connected to the torque converter, a lock-up clutch housed in the torque converter where the lock-up clutch is configured to mechanically connect the engine and the transmission when the lock-up clutch is engaged, and an engine control module configured to operate the engine at a first torque lug curve when the lock-up clutch is engaged and operate the engine at a second torque lug curve when the lock-up clutch is disengaged.

In accordance with another aspect of the disclosure, a method for operating a lock-up clutch in an engine control system is provided. The method includes operatively connecting an engine to a torque converter, operatively connecting a transmission to the torque converter, housing the lock-up clutch in the torque converter, configuring the lock-up clutch to mechanically connect the engine and the transmission when the lock-up clutch is engaged and configuring an engine control module to operate the engine at a first torque lug curve when the lock-up clutch is engaged and operate the engine at a second torque lug curve when the lock-up clutch is disengaged.

In accordance with another aspect of the disclosure, an apparatus is provided that includes a torque converter, an engine operatively connected to the torque converter, a transmission operatively connected to the torque converter, a lock-up clutch housed in the torque converter, a means for configuring the lock-up clutch to mechanically connect the engine and the transmission when the lock-up clutch is engaged, a means for determining whether the lock-up clutch is engaged or disengaged, means for operating the engine at a first torque lug curve when the lock-up clutch is engaged and means for operating the engine at a second torque lulg curve when the lock-up clutch is disengaged.

### BRIEF DESCRIPTION OF THE FIGURES

FIG. 1 shows a schematic illustration of an exemplary engine control system of the disclosure.

FIG. 2A shows a cross-section view of an exemplary torque converter of the engine control system where the lock-up clutch is disengaged.

FIG. 2B shows a cross-section view of an exemplary torque converter of the engine control system where the lock-up clutch is engaged.

FIG. 3 is a graph showing the torque converter output speed during engagement of the lock-up clutch in a torque converter without using the methods and systems disclosed herein.

FIG. 4 is a graph showing the torque converter output speed during disengagement of the lock-up clutch in a torque converter without using the methods and systems disclosed herein.

FIG. 5 presents a flow chart illustrating a control strategy for operating the lock-up clutch in a torque converter according to an embodiment of the present disclosure.

In this respect, before explaining at least one embodiment of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### DETAILED DESCRIPTION OF THE DISCLOSURE

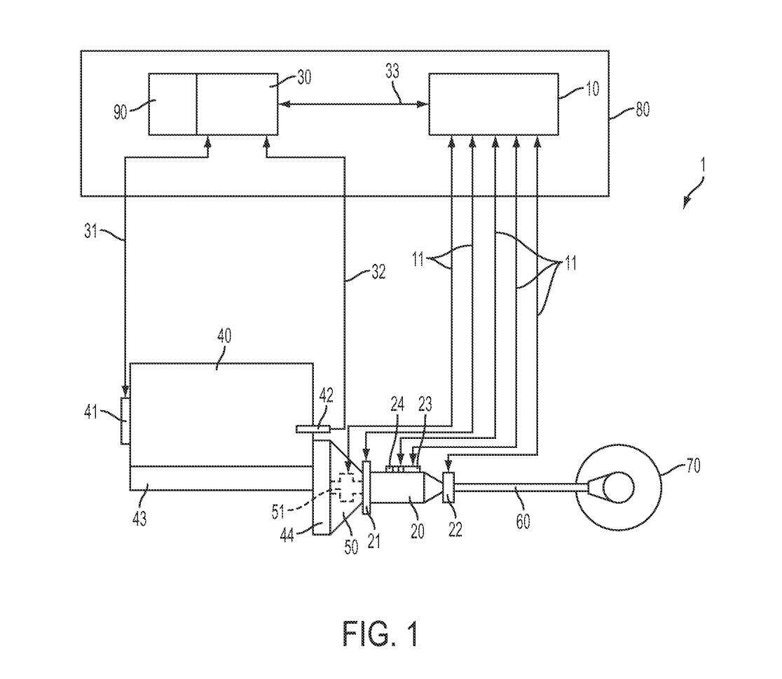

Referring to FIG. 1, a schematic illustration of an exemplary engine control system 1 of the disclosure is shown. The engine control system 1 may include an engine 40, a transmission 20 and a torque converter 50.

The engine control system 1 may further include an engine controller 30 and a transmission controller 10 which are embodied in separate or combined microprocessors adapted to communicate via an electrical or data link. Numerous commercially available microprocessors can be adapted to perform the functions of the engine controller 30 and the transmission controller 10. The input of the transmission 20 may be connected to and driven by the engine 40 through the torque converter 50 equipped with a lock-up clutch (LUC) 51. The torque converter 50 may be connected to an engine flywheel 44 and further to an engine crankshaft 43.

The transmission controller 10 may be adapted to receive inputs including an engine speed signal, and effect gear changes in the transmission 20. The engine control system 1 may be provided with a plurality of solenoids 24. A transmission input speed sensor 21 may be connected to the transmission 20 and produce a transmission input speed signal that is a function of the transmission input speed. The transmission input speed signal may be delivered to the transmission controller 10 via an electrical link 11. A transmission output speed sensor 22 may be connected to the transmission 20 and produce a transmission output speed signal that is a function of the transmission output speed. The transmission output speed signal may be delivered to the transmission controller 10 via an electrical link 11. The output of the transmission 20 may be connected to and adapted to rotatably drive a shaft 60. The shaft 60 may be in turn connected to and adapted to drive a ground engaging wheel 70, thereby propelling a machine.

The engine controller 30 may be adapted to receive operating parameters including an engine speed signal. The engine controller 30 may process the received signals to produce a fuel injection control signal for adjusting the fuel delivery to the engine 40 based on the received signals. In one aspect, the engine controller 30 may be connected, via an electrical link 31, to an engine speed sensor 41 which is adapted to sense an engine speed and produce an engine speed signal. In some aspects, the engine controller 30 is capable of determining the speed, angular position and direction of rotation of a rotatable shaft.

The operation of the engine control system 1 may begin at an Electronic Control Module (ECM) 80. The ECM 80 may receive information about the operation of the engine control system 1 through a plurality of sensors 21, 22, 23, 41, 42. The ECM 80 may use the information from the plurality of sensors 21, 22, 23, 41, 42 to control the engine 40, the torque converter 50 and the transmission 20, respectively. The transmission controller 10 and the engine controller 30 may be communicatively connected to the ECM 80. In one aspect, the transmission controller 10 and the engine controller 30 may be integrated in the ECM 80. For example, the ECM 80 may control the quantity of fuel that is injected into the engine 40 per engine cycle, ignition timing, variable valve timing, and operations of other engine components. Accordingly, the ECM 80 may control or dictate the parameters by which the engine operates. These ECM 80 controls may be implemented through software instructions.

The engine control system 1 may further include an idle speed control (ISC) unit 90. The ISC unit 90 may regulate engine idle speed. The ISC unit 90 may provide stabilization of the engine when loads are applied to the engine 40. In one aspect, the ISC unit 90 may adjust the idle speed of the engine 40 under at least one or more of conditions such as a high idle, a low idle, a warm curb idle, an air conditioner idle, an electrical load, and an automatic transmission load. In some aspects, the ISC unit 90 may be controlled by the ECM 80.

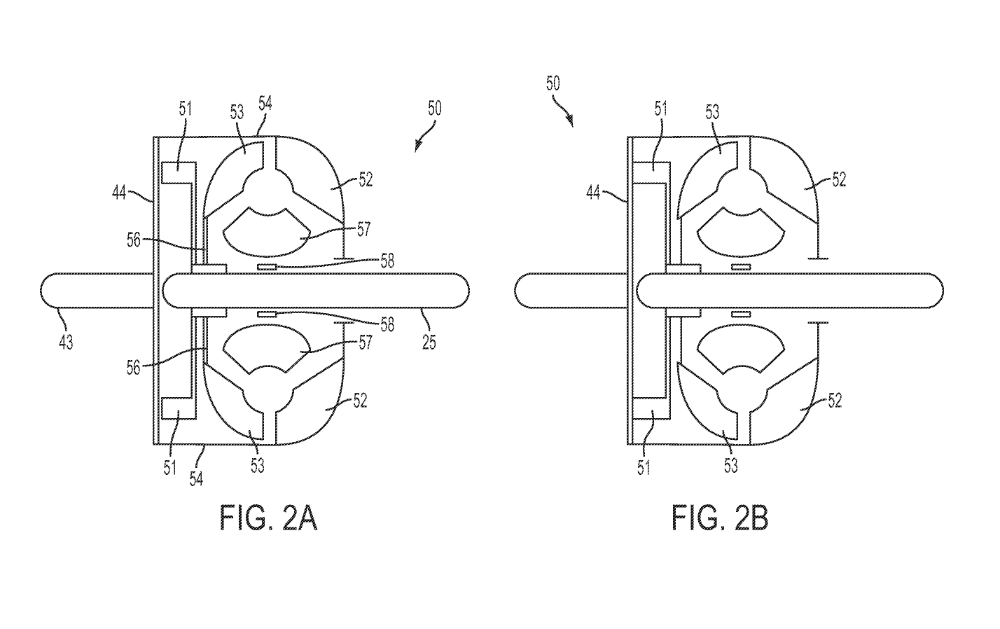

FIG. 2A shows a cross-section view of an exemplary torque converter 50 of the engine control system 1 where the lock-up clutch 51 is disengaged. The torque converter 50 may include a pump impeller 52 and a turbine 53. The rotating housing 54 of the torque converter 50 may be fastened directly to an engine flywheel 44.

The pump impeller 52 may be connected to a crankshaft 43 of the engine. In one aspect, the pump impeller 52 may be integrated with the torque converter housing 54. In some aspects, the pump impeller 52 may be driven by the crankshaft 43. The fluid in the pump impeller 52 may rotate with the pump impeller 52 so that as the pump impeller speed increases, centrifugal force causes the fluid to flow outward toward the turbine 53.

The turbine 53 may be located inside the torque converter 50. In one aspect, the turbine 53 may not be connected to the torque converter housing 54. The transmission shaft 25 of the transmission 20 may be attached by the splines 56 to the turbine 53 when the torque converter 50 is mounted to the transmission 20. In some aspects, the fluid flown outward from the pump impeller 52 may be transferred to the turbine 53, thereby turning the turbine 53 in the same direction as the engine crankshaft 43.

Optionally, the torque converter 50 may further include a stator 57. The stator 57 may be located between the pump impeller 52 and the turbine 53. The stator 57 may redirect the fluid that exits the turbine 53 toward the pump impeller 52.

The torque converter 50 may also include a one-way clutch 58 for torque converter drive. The one-way clutch 58 may allow the stator 57 to rotate in the same direction as the transmission shaft 25. The torque converter 50 may use a hydraulic system that uses oil that is also common with a brake cooling system, a parking brake release system, and a body hoist system. Thus, during the torque converter drive, the torque converter 50 may drive the transmission 20 hydraulically.

The torque converter 50 may include a lock-up clutch 51 for direct drive. The lock-up clutch 51 may be implemented in the torque converter 50 to lock the engine 40 and the transmission 20. The lock-up clutch 51 may be placed in front of the turbine 53. During the direct drive, the lock-up clutch 51 may connect the engine crankshaft 43 and the transmission shaft 25 to mechanically couple the engine 40 and the transmission 20.

FIG. 2B shows a cross-section view of an exemplary torque converter 50 of the engine control system 1 where the lock-up clutch 51 is engaged. When the lock-up clutch 51 is engaged to connect the engine 40 and the transmission 20, the lock-up clutch 51 may rotate together with the pump impeller 52 and the turbine 53. In various aspects, the lock-up clutch 51 may cause the engine 40 and the transmission 20 to turn at the speed of the engine 40. When the lock-up clutch 51 is engaged, 95% or more of the power generated by the engine 40 may be transmitted to the transmission 20. In certain aspects, 100% of the power generated by the engine 40 may be transmitted to the transmission 20.

Optionally, as shown FIG. 1, the lock-up clutch 51 may be communicably connected to the ECM 80 so that the lock-up clutch 51 can be controlled by the ECM 80. The ECM 80 may activate the lock-up clutch 51 when direct drive is necessary. When the lock-up clutch 51 is activated, the lock-up clutch 51 may be hydraulically engaged. As the lock-up clutch 51 is engaged, the lock-up clutch 51 may place the torque converter 50 in direct drive, and the full power from the engine 40 may be transmitted through the torque converter 50. Engine speed is normally controlled in response to a desired engine speed signal. During engagement of the lock-up clutch 51, the transmission speed is regulated in response to the speed of the engine 40. As the lock-up clutch 51 engages, the speed of the engine 40 may be faster than the transmission speed. This difference in engine speed and transmission speed causes sudden machine acceleration when the lock-up clutch 51 moves from a disengaged position to an engaged position. Depending on the duration of the acceleration period, the operator may feel a rough shift or a shift with unacceptable acceleration. This unexpected change in machine speed diminishes the operator's ability to maintain precise control of the machine during fine dozing applications and as a result may negatively affect the operator's perception of machine quality.

During disengagement of the lock-up clutch 51, the transmission speed is regulated in response to the speed of the engine 40. As the lock-up clutch 51 disengages, the speed of the transmission 20 may decrease below the engine speed. This difference in engine speed and transmission speed causes sudden machine deceleration when the lock-up clutch 51 moves from an engaged position to a disengaged position. Depending on the duration of the deceleration period, the operator may feel a rough shift or a shift with unacceptable deceleration. This unexpected change in machine speed diminishes the operator's ability to maintain precise control of the machine during fine dozing applications and as a result may negatively affect the operator's perception of machine quality.

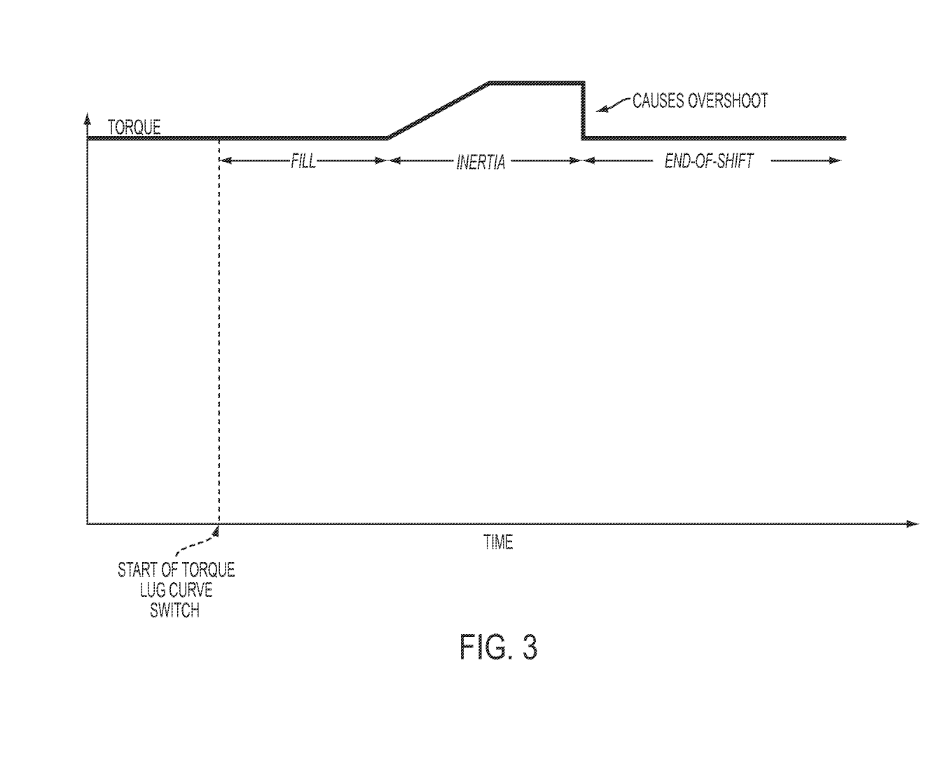

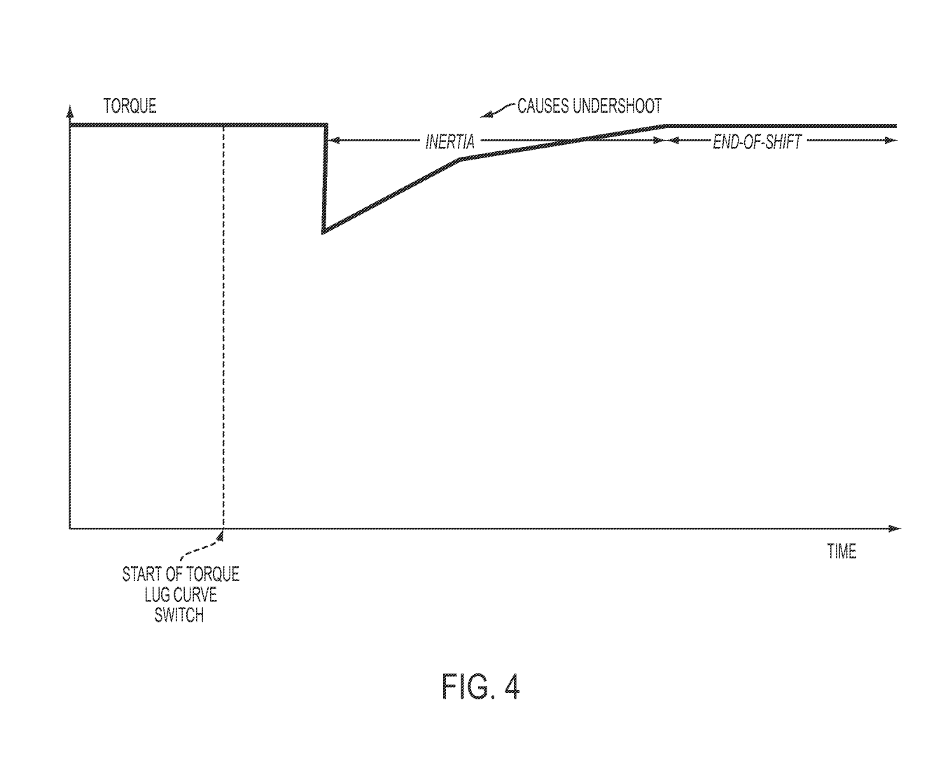

FIGS. 3 and 4 graphically illustrate the performance of a lock-up clutch 51 during engagement and disengagement, respectively. For example, FIG. 3 shows the torque converter output speed over a period of time as the lock-up clutch 51 engages. As shown, there is an overshoot in torque converter output speed that results from engagement of the lock-up clutch 51. The overshoot in torque converter output speed results in an increase in engine power transmitted due to the increase in efficiency because the lock-up clutch 51 is engaged. This overshoot creates the undesired acceleration or the jerking motion. Engagement of the lock-up clutch 51 occurs during the inertia phase shown in FIG. 3. The inertia phase is characterized by an increase in lock-up clutch 51 pressure indicating that the lock-up clutch 51 is starting to engage. As shown, the inertia phase immediately increases the engine speed and continues to do so, causing the overshoot. Once the lock-up clutch 51 pressure stabilizes, the lock-up clutch 51 is then fully engaged and the shift has ended. The overshoot therefore occurs only during the inertia phase.

FIG. 4 shows the torque converter output speed over a period of time as the lock-up clutch 51 disengages. As shown, disengagement of the lock-up clutch 51 causes a decrease in torque converter output speed referred to as an undershoot. This undershoot may also be referred to as engine droop. The undershoot causes a sudden deceleration in the vehicle caused by the loss in transmitted engine power from disengagement of the lock-up clutch 51 because the hydraulic transfer of power is less efficient. Disengagement of the lock-up clutch 51 can be seen in the inertia phase indicated in FIG. 4. The inertia phase here is characterized by a decrease in lock-up clutch 51 pressure and indicates that the lock-up clutch 51 is starting to disengage. Once the lock-up clutch 51 pressure stabilizes, the lock-up clutch 51 has fully disengaged and the shift has ended. The undershoot occurs during the inertia phase.

To improve driving performance by reducing or preventing the shift shock, the overshoot illustrated in FIG. 3 and the undershoot illustrated in FIG. 4 during the inertia phase must be minimized. According to one embodiment of the present disclosure, this is accomplished by operating the engine 40 at a first torque lug curve when the lock-up clutch 51 is engaged and operating the engine at a second torque lug curve when the lock-up clutch 51 is disengaged. The first torque lug curve and the second torque lug curve represent different modes of operating the engine 40. These curves represent the total quantity of torque that the engine 40 can produce at a given engine speed and under a set a given set of conditions. The first and second torque lug curves incorporate a variety of engine operating parameters, such as fuel amount, so that the torque converter output speed is proportionately adjusted in response to the engagement or disengagement of the lock-up clutch 51.

For example, in one aspect of the present disclosure, the torque converter output speed may be reduced by running the engine 40 at a first torque lug curve. When the lock-up clutch 51 is engaged, the engine 40 is more efficient, generates a higher torque converter output speed and has more power. The vehicle may either run using this additional engine power or the engine 40 may adjust its operation such that engine power is reduced. In order to minimize the overshoot, the torque converter output speed must be reduced to counteract the additional efficiency that the engine 40 has when the lock-up clutch 51 is engaged. The first torque lug curve adjusts certain engine operating parameters to proportionately reduce the torque converter output speed in response to lock-up clutch 51 engagement. By adjusting the amount of power that the engine 40 generates during engagement of the lock-up clutch 51, the overshoot is minimized and a substantial amount of fuel may be conserved making it less costly to operate the vehicle.

According to an embodiment of the present disclosure, the torque converter output speed may be reduced by running the engine 40 at a second torque lug curve. When the lock-up clutch 51 is disengaged, the engine 40 is less efficient, generates a lower torque converter output speed and has less power. In order to minimize the undershoot, the torque converter output speed must be increased to counteract the inefficiency that the engine 40 has when the lock-up clutch 51 is disengaged. The second torque lug curve adjusts certain engine 40 operating parameters to proportionately increase the torque converter output speed in response to lock-up clutch 51 disengagement. By adjusting the amount of power that the engine 40 generates during disengagement of the lock-up clutch 51, the undershoot is minimized.

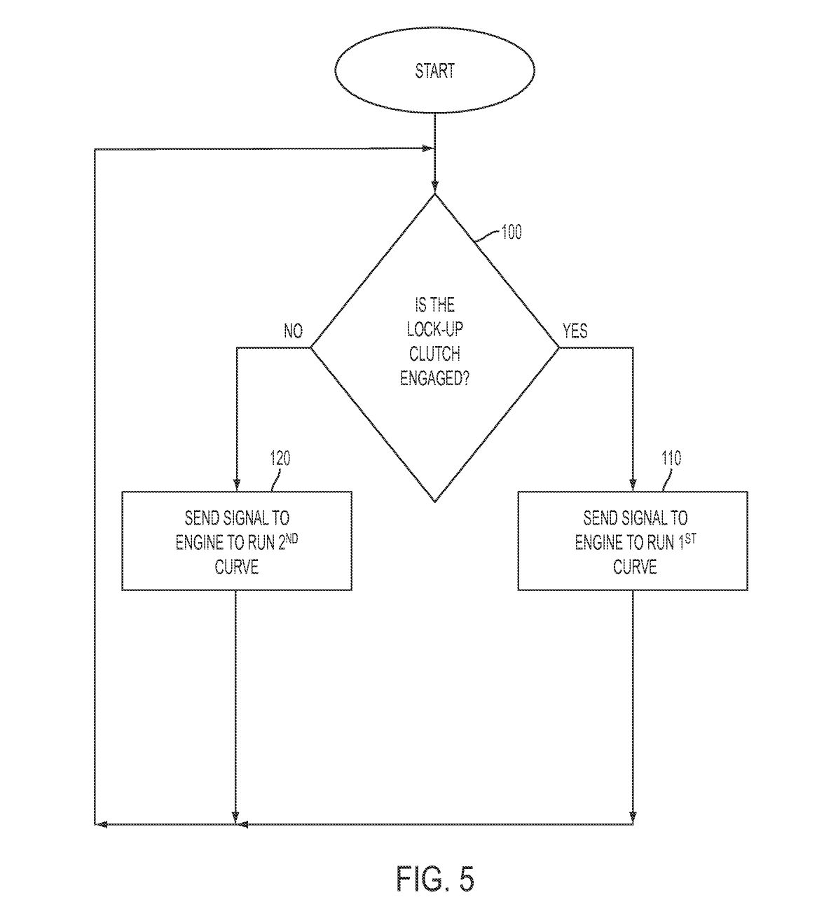

Referring now to FIG. 5, a flow chart showing steps to control the engine 40 to minimize the overshoot or undershoot. At 100, the ECM 80 determines whether the lock-up clutch 51 is engaged.

In one aspect, this determination may be based on whether or not the ECM 80 has activated the lock-up clutch 51. As explained above, the ECM 80 is connected to the lock-up clutch 51 and is configured to engage the lock-up clutch 51. The transmission controller 10 commands the ECM 80 to activate the lock-up clutch 51 based on certain conditions. When the ECM 80 receives the activation command from the transmission controller 10, the ECM 80 may signal the engine 40 to run the first torque lug curve. The ECM 80 at 100 may then monitor a measured parameter such as lock-up clutch 51 pressure, engine speed, engine torque, engine acceleration, and torque converter output speed to determine whether or not the lock-up clutch 51 remains engaged. For example, in one embodiment, the ECM 80 is configured to determine whether the lock-up clutch 51 is engaged based on the engine speed data received from the engine speed sensors 41, 42. The engine speed sensors 41, 42 may transmit information such as the current engine speed, the desired engine speed. There may also be a transmission speed sensor that is configured to measure the transmission speed. The ECM 80 may then determine whether or not the lock-up clutch 51 is engaged based on the data it receives from the engine speed sensor and transmission speed sensor.

In one embodiment according to the present disclosure, the engine control system 1 may include an engine speed sensor to obtain a prior engine speed which is measured prior to a state change of the lock-up clutch 51. The system 1 may also include a transmission speed sensor configured to obtain a prior transmission speed which is measured prior to a state change of the lock-up clutch 51. The ECM 80 may be configured to determine a desired engine speed different than the prior engine speed and to adjust a speed of the engine to the desired engine speed at least one of just prior to the movement of the lock-up clutch 51 and as the lock-up clutch 51 moves toward the engagement.

The ECM 80 may further be configured to incrementally change a speed of the engine 40 to the desired engine speed and adaptively adjust an amount of incremental speed change of the engine 40 as a function of a difference between the prior transmission speed and the prior engine speed.

Optionally, the ECM 80 is further configured to determine the desired engine speed as a function of increase in efficiency of the torque converter due to the lock-up clutch 51 engagement where the torque converter efficiency is defined by any of a speed ratio between a transmission speed and an engine speed, a torque ratio between the transmission 20 and the engine 40, and a product of the speed ratio and the torque ratio and where a value of the torque converter efficiency prior to the lock-up clutch 51 engagement is lower than a value of the torque converter efficiency after the lock-up clutch 51 engagement. The lock-up clutch 51 is configured to increase the torque converter efficiency up to 100% when the lock-up clutch 51 is engaged.

The ECM 80 is further configured to determine the desired engine speed at a speed which is different from the prior engine speed in an amount proportional to a projected change in torque converter efficiency due to the lock-up clutch 51 state change. Optionally, the transmission controller 10 is further configured to activate a lock-up engagement command, determine a transition time to complete the lock-up clutch 51 engagement and complete the lock-up clutch 51 engagement for the transition time while communicating with the engine control module, which adjusts a speed of the engine to the desired engine speed.

If the lock-up clutch 51 is engaged, then at 110, the ECM 80 responds by commanding the engine 40 to operate the first torque lug curve. The engine 40 should continue to run at the first torque lug curve until at 100 the ECM 80 determines that the lock-up clutch 51 is no longer engaged.

If the lock-up clutch 51 is not engaged, then at 120, the ECM 80 responds by commanding the engine 40 to operate the second torque lug curve. In one aspect, this determination may be based on whether or not the ECM 80 has de-activated the lock-up clutch 51. Again, the ECM 80 is connected to the lock-up clutch 51 and is therefore configured to disengage the lock-up clutch 51. The transmission controller 10 may command the ECM 80 to deactivate the lock-up clutch 51 based on certain conditions. The ECM 80 may respond to the deactivation command by disengaging the lock-up clutch 51 and commanding the engine 40 to switch its operation to the second torque lug curve. The engine 40 should continue to run at the second torque lug curve until at 100 the ECM 80 determines that the lock-up clutch 51 is no longer disengaged or engaged.

The timing of the engine's 40 switch to the first or second torque lug curve is also important to minimizing the engine's 40 overshoot or undershoot. The engine's 40 switch from one torque lug curve to the other torque lug curve is preferably made prior to the actual engagement or disengagement of the lock-up clutch 51 or during the transition process of engaging or disengaging the lock-up clutch 51. If the switch occurs too late or after the lock-up clutch 51 has already engaged then there is not an opportunity to reduce the overshoot and the operator may feel the shift at least to some extent. Similarly, if the switch occurs after the lock-up clutch 51 has already disengaged then there may still be an undershoot and the operator may feel the shift at least to some extent. In one embodiment according to the present disclosure, the, ECM 80 signals the engine to switch torque lug curves prior to the movement of the lock-up clutch 51 for engagement or as the lock-up clutch 51 moves toward disengagement. For example, FIG. 3 graphically illustrates a point in time prior to the actual engagement of the lock-up clutch 51 to start the switch from the second torque lug curve to the first torque of the torque lug curve. Similarly, FIG. 4 graphically illustrates a point in time prior to the actual disengagement of the lock-up clutch 51 to start the switch from the first torque lug curve to the second torque lug curve.

### INDUSTRIAL APPLICABILITY

The disclosure may be applicable to any engine control system 1 where control of a lock-up clutch 51 is desired. Specifically, the disclosure may be applicable to an electronic control module (ECM) 80 with an internal model that calculates a desired engine speed and adjusts a speed of the engine 40 to the desired engine speed during the engagement of the lock-up clutch 51.

The engine control system 1 may embody a combustion engine 40, such as, for example, a diesel engine, a gasoline engine, a gaseous fuel-powered engine (e.g., a natural gas engine), or any other type of combustion engine known to one skilled in the art. The solenoids 24 may connect an electrical system and a hydraulic system in the engine control system 1.

The transmission 20 may be an automatic transmission. The automatic transmission 20 may have a separate hydraulic system. The automatic transmission 20 may be connected to the transmission controller 10. The transmission controller 10 may be adapted to receive inputs including a vehicle speed signal. In addition, the automatic transmission 20 may be capable of being mechanically connected to the lock-up clutch 51 during operation of the engine control system 1. To control the automatic transmission 20, the transmission controller 10 may include a central processing unit (CPU), a read-only memory (ROM), a random-access memory (RAM) and an interface. The CPU may be configured to process the input signals according to various control programs stored in the ROM for controlling the automatic transmission 20. The transmission controller 10 may be integrated in the ECM 80.

The engine controller 30 may include a microcomputer including a central processing unit (CPU), a read-only memory (ROM), a random-access memory (RAM) and an interface. The engine controller 30 may be configured to receive signals from various sensors 41, 42, such as a mass air flow sensor, a temperature sensor, a Hall effect sensor, a pressure sensor, and an engine speed sensor.

The engine controller 30 may be configured to process the received signals including a desired speed signal, an actual engine signal, and responsively regulate engine speed in a closed-loop controller. In particular, the engine controller 30 may be communicably connected to an engine speed sensor 41 which is adapted to sense an engine speed and produce an engine speed signal. The engine controller 30 may be further connected to an engine temperature sensor which is connected to the engine 40 and produce an engine temperature signal.

The engine controller 30 may process the received signals to regulate the fuel delivery to the engine 40 in response to a difference between a desired engine speed signal and an actual engine speed signal. In one aspect, the engine controller 30 may be adapted to control an engine output according to a command from the transmission controller 10. The engine controller 30 may utilize various speed control strategies. For example, the engine controller 30 may regulate the actual engine speed to correspond with the desired engine speed using proportional-integral-differential (PID) control loop. The engine controller 30 may be integrated in the ECM 80.

The transmission controller 10 and the engine controller 30 may be communicably connected to the ECM 80. The ECM 80 may receive information of the engine control system 1 from a plurality of sensors, 21, 22, 23, 41, 42 to control the torque converter 50 and the transmission 20 by energizing the appropriate solenoids 24.

The ECM 80 may activate the lock-up clutch 51 when direct drive is necessary. When the lock-up clutch 51 is activated, the lock-up clutch 51 may be hydraulically engaged. In one aspect, the lock-up clutch 51 may become a connection between the rotating housing 54 and a transmission shaft 25. The transmission shaft 25 may mechanically connect the torque converter 50 and the transmission 20. The power that is flowing through the torque converter 50 can be hydraulic or mechanical.

The ECM 80 may include an input circuit to perform various functions to process input signals from a plurality of sensors, 21, 22, 23, 41, 42 regulate the voltage levels of the sensors 21, 22, 23, 41, 42 and produce output signals to control the engine 40, the transmission 20 and the lock-up clutch 51. The ECM 80 may be equipped with a central processing unit (CPU), a read-only memory (ROM), a random-access memory (RAM) and an interface. The ROM may store various operating programs which are executed by the CPU, and the RAM may store results of calculations from the CPU. The ECM 80 may further include an output circuit which outputs and delivers output signals to the torque converter 50.

The operating programs may include various engine speed control strategies for the lock-up clutch engagement. In one aspect, the program may configure the ECM 80 to determine a desired engine speed and incrementally change a speed of the engine 40 to the desired engine speed as the lock-up clutch changes state. In some aspects, the program may configure the ECM 80 to determine the desired engine speed at a speed which is different than the engine speed in an amount proportional to a projected increased amount of the torque converter efficiency due to the lock-up clutch engagement. In various aspects, the program may configure the ECM 80 to determine a transition profile necessary for completing the lock-up clutch engagement. Optionally, the program may utilize a combination of those various engine speed control strategies.

The disclosure is universally applicable for use in an ECM 80 for many types of off highway machines, such as, for example, machines associated with industries such as mining, construction, farming, transportation, etc. For example, the machine may be an earth-moving machine, such as a track type tractor, track loader, wheel loader, excavator, dump truck, backhoe, motor grader, material handler, etc. Additionally, one or more implements may be connected to the machine, which may be used for a variety of tasks, including, for example, brushing, compacting, grading, lifting, loading, plowing, ripping, and include, for example, augers, blades, breakers/hammers, brushes, buckets, compactors, cutters, forked lifting devices, grader bits and end bits, grapples, moldboards, rippers, scarifiers, shears, snow plows, snow wings, etc. Similarly, the disclosure is universally applicable for use in an electronic control module (ECM) 80 for many types of generator sets that typically include a generator and a prime mover.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. An engine control system, comprising:
a torque converter;
an engine operatively connected to the torque converter;
a transmission operatively connected to the torque converter;
a lock-up clutch housed in the torque converter wherein the lock-up clutch is configured to mechanically connect the engine and the transmission when the lock-up clutch is engaged; and
an engine control module configured to:
operate the engine at a first torque lug curve when the lock-up clutch is engaged and operate the engine at a second torque lug curve when the lock-up clutch is disengaged.

2. The control system of claim 1, wherein the torque converter has an efficiency up to 100% when the lock-up clutch is engaged.

3. The engine control system of claim 1, wherein the engine operates at the first torque lug curve as the lock-up clutch moves toward engagement or prior to the movement of the lock-up clutch for the engagement.

4. The engine control system of claim 1, wherein the engine operates at the second torque lug curve as the lock-up clutch moves toward disengagement or prior to the movement of the lock-up clutch for the disengagement.

5. The engine control system of claim 1, wherein the second torque lug curve increases engine torque and transmission speed compared to operating the engine at the first torque lug curve.

6. The engine control system of claim 1, wherein the first torque lug curve decreases engine torque and transmission speed compared to operating the engine at the second torque lug curve.

7. The control system of claim 1, further comprising an engine controller and a transmission controller in communication with the engine controller, wherein the engine controller and the transmission controller are connected to the engine control module.

8. The control system of claim 7, wherein the engine controller is configured to send an activate command to the transmission controller to engage the lock-up clutch and a de-activate command to the transmission controller to disengage the lock-up clutch.

9. The engine control system of claim 7, wherein the engine control module receives communication from the transmission controller to operate the engine at the first torque lug curve in response to the activate command.

10. The engine control system of claim 7, wherein the engine control module receives communication from the transmission controller to operate the engine at the second torque lug curve in response to the de-activate command.

11. The engine control system of claim 8, further comprising an engine speed sensor connected to the engine controller and configured to measure engine speed and transmit a measured engine speed to the engine controller, wherein the engine controller is configured to determine a difference between a desired engine speed and the measured engine speed.

12. The engine control system of claim 11, wherein the engine controller is configured to send the activate command or the de-active command to the transmission controller based on the difference between the desired engine speed and the measured engine speed.

13. A method for operating a lock-up clutch in an engine control system, comprising:
operatively connecting an engine to a torque converter;
operatively connecting a transmission to the torque converter;
housing the lock-up clutch in the torque converter;
configuring the lock-up clutch to mechanically connect the engine and the transmission when the lock-up clutch is engaged;
configuring an engine control module to:
operate the engine at a first torque lug curve when the lock-up clutch is engaged and
operate the engine at a second torque lug curve when the lock-up clutch is disengaged.

14. The method according to claim 12, further comprising:
operatively connecting the transmission controller to an engine controller and
configuring the engine controller to send an activate command to the transmission controller to engage the lock-up clutch and
configuring the engine controller to send a de-activate command to the transmission controller to disengage the lock-up clutch.

15. The method according to claim 12, wherein operating the engine at the second torque lug curve increases engine torque and transmission speed compared to operating the engine at the first torque lug curve.

16. The method according to claim 12, wherein operating the engine at the first torque lug curve decreases engine torque and transmission speed compared to operating the engine at the first torque lug curve.

17. The method according to claim 13, wherein the torque converter has an efficiency up to 100% when the lock-up clutch is engaged.

18. The method according to claim 13, wherein the engine operates at the first torque lug curve as the lock-up clutch moves toward engagement or prior to the movement of the lock-up clutch for the engagement.

19. The method according to claim 13, wherein the engine operates at the second torque lug curve as the lock-up clutch moves toward disengagement or prior to the movement of the lock-up clutch for the disengagement.

20. An apparatus, comprising:
a torque converter;
an engine operatively connected to the torque converter;
a transmission operatively connected to the torque converter;
a lock-up clutch housed in the torque converter;
means for configuring the lock-up clutch to mechanically connect the engine and the transmission when the lock-up clutch is engaged;
means for determining whether the lock-up clutch is engaged or disengaged;
means for operating the engine at a first torque lug curve when the lock-up clutch is engaged; and
means for operating the engine at a second torque lug curve when the lock-up clutch is disengaged.
